(19) United States
(12) Patent Application Publication
(10) Pub. No.: US 2024/0149261 A1
(43) Pub. Date: May 9, 2024

(54) COATED CUT METAL BODIES AND PROCESSES FOR THE PRODUCTION THEREOF

(71) Applicant: EVONIK OPERATIONS GMBH, Essen (DE)

(72) Inventors: Meike ROOS, Büdingen (DE); Monika BERWEILER, Maintal (DE); Markus GÖTTLINGER, Rodenbach (DE); René POSS, Karlsruhe (DE)

(73) Assignee: EVONIK OPERATIONS GMBH, Essen (DE)

(21) Appl. No.: 18/283,156

(22) PCT Filed: Mar. 14, 2022
(86) PCT No.: PCT/EP2022/056426

§ 371 Date: Sep. 20, 2023

(30) Foreign Application Priority Data
Mar. 23, 2021 (EP) 21164243.4

(51) Int. Cl. B01J 37/00; B01J 25/02; B01J 37/08

(52) U.S. Cl. CPC B01J 37/0027; B01J 25/02; B01J 37/08

(57) ABSTRACT

The present invention relates to processes for producing cut metal bodies, comprising the providing of metal bodies, the subsequent applying of metal-containing powders, a thermal treatment for alloy formation and the splitting of the alloyed metal bodies using a process selected from the group: severing, machining with geometrically defined cutting edge and waterjet cutting. The temperature profile in the thermal treatment allows alloy formation to take place at the contact surface between metal body and metal-containing powder, but at the same time leaving unalloyed regions in the interior of the metal body. The present invention further relates to processes in which the splitting of the alloyed metal bodies is followed by a treatment with leaching agent so as to obtain catalytically active metal bodies. The use of the inventive splitting process for producing the cut metal bodies affords particularly active catalysts. The present invention further relates to the use of the catalysts obtained by the processes of the invention in chemical transformations.

### BACKGROUND

The present invention relates to processes for producing cut metal bodies, comprising the providing of metal bodies, the subsequent applying of metal-containing powders, a thermal treatment for alloy formation and the splitting of the alloyed metal bodies using a process selected from the group: severing, machining with geometrically defined cutting edge and waterjet cutting. The present invention further relates to processes in which production of the cut metal bodies is followed by a treatment with leaching agent. One field of use for processes of this kind is in the production of catalysts. Alongside a temperature regime for the thermal treatment that allows alloy formation to be limited to the upper layers of the metal foam, a characteristic feature of the processes of the invention is the use of the inventive splitting processes for producing the cut metal bodies to afford catalysts having particularly advantageous properties. The present invention further relates to the metal bodies obtainable by the processes of the invention, which find use for example as support and structural components and in catalyst technology, and to the use of the catalysts obtained by the processes of the invention in chemical transformations.

### PRIOR ART

Processes for producing alloyed metal foam bodies are known from the prior art, for example from WO2019057533A1. Metal powders are therein applied to foam-form metal bodies, followed by a thermal treatment to form alloys in the area of contact of the foam-form metal body and metal powder. WO2019057533A1 discloses a multitude of metals and metal combinations that may be chosen for the foam-form metal body and the metal powder, and also general details for the performance of the thermal treatment for alloy formation and some specific examples for the treatment of aluminium powder on nickel foam.

The present invention differs from the technical teaching of WO2019057533A1 inter alia in respect of the conditions for the thermal treatment for alloy formation and in respect of the splitting processes for producing the cut metal bodies.

The conditions for the thermal treatment for alloy formation have an influence on the extent of alloy formation. Thermal treatment at high temperatures leads to alloy formation in deeper regions of the metal body, whereas thermal treatment at lower temperatures leads only to alloy formation in the upper regions of the metal body, leaving unalloyed regions in the interior of the metal body. Since the persistence of unalloyed regions in the metal body is of major importance in a great many uses of corresponding metal bodies, there is a need for processes that ensure this. The processes of the present invention meet this need.

Experimental investigations carried out in connection with the present invention show that the splitting process used for producing the cut metal bodies has an influence on the properties of the catalysts obtained: If unsuitable splitting processes are employed, this results inter alia in adverse effects on the activity of the catalysts obtained. Since highly active catalysts are needed for many practical uses, there is a need for processes suitable for the production thereof. The processes of the present invention meet this need.

### The Present Invention

The processes of the invention comprise the following steps:
(a) providing a metal body A,
(b) applying a metal-containing powder MP to metal body A so as to obtain metal body AX,
(c) treating metal body AX thermally to achieve alloy formation between the metallic fractions of metal body A and the metal-containing powder MP so as to obtain metal body B,
(d) splitting of the metal bodies B so as to obtain cut metal bodies MZ,
wherein the splitting of the metal bodies B in step (d) employs a splitting process selected from the following group:
severing, machining with geometrically defined cutting edge, waterjet cutting,
and wherein the maximum temperature in the thermal treatment of metal body AX is within a range from 680 to 715° C.,
and wherein the total duration of thermal treatment in a temperature range from 680 to 715° C. is between 5 and 240 seconds,
and wherein metal body A is made of nickel, of cobalt, of a cobalt-nickel alloy, of a nickel-iron alloy, of a nickel-chromium alloy, or of copper,
and wherein the metal-containing powder MP comprises pulverulent aluminium, pulverulent chromium, a pulverulent alloy of aluminium and chromium, or combinations thereof,
and wherein the metal body used in step (a) is a metal foam body, a metal net, a metal nonwoven, a metal knit, or a metal mesh.

The processes of the invention allow alloy formation to be limited to the upper layers of the metal body, so that unalloyed regions remain in central regions of the metal body. The presence of these unalloyed regions influences inter alia the chemical and mechanical stability of the metal body obtained.

The metal body used in step (a) of the process of the invention is a metal foam body, a metal net, a metal nonwoven, a metal knit, or a metal mesh.

In a preferred embodiment, the metal body used in step (a) is a metal foam body.

The metal body used in step (a) of the process of the invention is made of nickel, of cobalt, of a cobalt-nickel alloy, of a nickel-iron alloy, of a nickel-chromium alloy, or of copper.

In a preferred embodiment, the metal body used in step (a) is made of nickel.

In a preferred embodiment, the metal body used in step (a) is a metal foam body made of nickel.

The metal body used in step (a) of the process of the invention may have any desired shape, for example cubic, cuboidal, cylindrical etc.

In a preferred embodiment, the metal body used in step (a) is cuboidal.

In a preferred embodiment, the metal body used in step (a) is a cuboidal metal foam body made of nickel.

In connection with the present invention, a metal foam body is understood to mean a foam-form metal body. Metal bodies in foam form are described for example in Ullmann's Encyclopedia of Industrial Chemistry, section “Metallic Foams”, published online on 15 Jul. 2012, DOI: 10.1002/14356007.c16_c01.pub2. Metal foams having different morphological properties—pore size and shape, layer thickness, area density, geometric surface area, porosity, etc.—are in principle suitable. Metal foam A preferably has a density within a range from 400 to 1500 g/m², a pore size of 400 to 3000 μm, preferably of 400 to 800 μm and a thickness within a range from 0.5 to 10 mm, preferably from 1.0 to 5.0 mm. Production can be carried out in a manner known per se. For example, a foam made of an organic polymer may be coated with a metal component and then the polymer removed by thermolysis, yielding a metal foam. For coating with a metal or a precursor thereof, the foam made of the organic polymer may be contacted with a solution or suspension containing the metal. This may be done for example by spraying or dipping. Deposition by means of chemical vapour deposition (CVD) is also possible. For example, a polyurethane foam may be coated with a metal and the polyurethane foam then thermolysed. A polymer foam suitable for producing shaped bodies in the form of a foam preferably has a pore size within a range from 100 to 5000 μm, more preferably from 450 to 4000 μm and in particular from 450 to 3000 μm. A suitable polymer foam preferably has a layer thickness of 5 to 60 mm, more preferably of 10 to 30 mm. A suitable polymer foam preferably has a density of 300 to 1200 kg/m³. The specific surface area is preferably within a range from 100 to 20 000 m²/m³, more preferably 1000 to 6000 m²/m³. The porosity is preferably within a range from 0.50 to 0.95.

In a preferred embodiment, the metal body used in step (a) is a metal foam body having a specific BET surface area of 100 to 20 000 m²/m³, preferably of 1000 to 6000 m²/m³.

In a further preferred embodiment, the metal body used in step (a) is a metal foam body in which the thickness of the metal layers that form the walls of the foam is in the range between 10 and 100 μm. The thickness of the metal layers that form the walls of the foam can be determined by standard microscopic investigations on cross sections of the foam.

In a further preferred embodiment, the metal body used in step (a) is a metal foam body having a porosity of 0.50 to 0.95.

As metal nets used as the metal body in step (a) of the process of the present invention, it is possible to use customary commercially available nets made of the corresponding metals. In a preferred embodiment, the metal body used in step (a) is a metal net in which the width of the meshes is in the range between 50 and 500 μm.

As metal knits used as the metal body in step (a) of the process of the present invention, it is possible to use customary commercially available knits made of correspondingly interwoven metal threads. In a preferred embodiment, the metal body used in step (a) is a metal knit in which the thread thickness is in the range between 50 and 500 μm.

As metal meshes used as the metal body in step (a) of the process of the present invention, it is possible to use customary commercially available meshes made of correspondingly knitted metal threads. In a preferred embodiment, the metal body used in step (a) is a metal mesh in which the thread thickness is in the range between 50 and 500 μm.

Metal nonwovens are commercially available. They consist typically of short metal fibres that are first pressed together and then sintered. As metal nonwovens used as the metal body in step (a) of the process of the present invention, it is possible to use customary commercially available nonwovens made of the corresponding metal fibres. In a preferred embodiment, the metal body used in step (a) is a metal nonwoven made of fibres having a thickness in the range between 50 and 500 μm.

The metal-containing powder MP may be applied in various ways in step (b) of the process of the invention, for example by contacting metal body A with a composition of metal-containing powder MP by rolling or dipping, or by applying a composition of metal-containing powder MP by spraying, scattering or pouring. The composition of metal-containing powder MP used for this purpose may be a suspension or in the form of a powder.

The actual applying of the composition of metal-containing powder MP to metal body A in step (b) of the process of the invention is preferably preceded by prior impregnation of metal body A with a binder. The impregnation can be accomplished, for example, by spraying on the binder or dipping metal body A into the binder, but is not limited to these options. Once this has been done, the composition of metal-containing powder MP can be applied to the metal body A thus prepared.

Alternatively, it is possible to apply binder and composition of metal-containing powder MP in one step. For this, either the composition of metal-containing powder MP is suspended in the liquid binder itself prior to application or the composition of metal-containing powder MP and the binder are suspended in an auxiliary fluid F.

The binder is a composition that can be completely converted into gaseous products by thermal treatment within a temperature range from 100 to 400° C. and comprises an organic compound that promotes adhesion of the composition of metal-containing powder MP on the metal body. The organic compound is preferably selected from the following group: polyethyleneimines (PEI), polyvinylpyrrolidone (PVP), ethylene glycol, mixtures of these compounds. Particular preference is given to PEI. The molecular weight of the polyethyleneimine is preferably within a range from 10 000 to 1 300 000 g/mol. The molecular weight of the polyethyleneimine (PEI) is preferably within a range from 700 000 to 800 000 g/mol.

Auxiliary fluid F must be able to form a suspension of the composition of metal-containing powder MP and the binder and to be completely converted into gaseous products by thermal treatment within a temperature range from 100 to 400° C. Auxiliary fluid F is preferably selected from the following group: water, ethylene glycol, PVP and mixtures of these compounds. When auxiliary fluid is used, the binder is typically suspended in water in a concentration within a range from 1% to 10% by weight, followed by suspension of the composition of metal-containing powder MP in this suspension.

The metal-containing powder MP used in step (b) of the process of the invention may, as well as pulverulent metal components, also contain additions that help increase flowability or water resistance. Such additions must be completely converted into gaseous products by thermal treatment within a temperature range from 100 to 400° C. The metal-containing powder MP used in step (b) of the process of the invention comprises one or more pulverulent metal components selected from the following group: pulverulent aluminium, pulverulent chromium, a pulverulent alloy of aluminium and chromium, or combinations thereof. Preferably, the metal-containing powder MP used in step (b) of the process of the invention comprises, as the sole metal component, either (i) aluminium powder, or (ii) chromium powder, or (iii) a mixture of pulverulent aluminium and pulverulent chromium, or (iv) a pulverulent alloy of aluminium and chromium. More preferably, the metal-containing powder MP used in step (b) of the process of the invention comprises, as the sole metal component, pulverulent aluminium. In a further preferred embodiment, the metal-containing powder MP used in step (b) of the process of the invention is pulverulent aluminium.

The composition of metal-containing powder MP preferably has a metal component content within a range from 80% to 99.8% by weight. Preference is given here to compositions in which the metal component particles have a particle size of not less than 5 μm and not greater than 200 μm. Particular preference is given to compositions in which 95% of the metal component particles have a particle size of not less than 5 μm and not greater than 75 μm. It may be the case that the composition, besides the metal component in elemental form, also contains metal components in oxidized form. This oxidized fraction is typically in the form of oxidic compounds, for example oxides, hydroxides and/or carbonates. The proportion by mass of the oxidized fraction is typically within a range from 0.05% to 10% by weight of the total mass of the metal powder composition.

The proportion of the mass of the applied metal-containing powder MP in the total mass of metal body AX is typically in a range between 5% and 60% by weight. In a preferred embodiment of the present invention, the proportion of the applied mass of the metal-containing powder MP in the total mass of metal body AX is in a range between 10% and 50% by weight, more preferably in a range between 20% and 40% by weight.

In step (c) of the process of the invention, a thermal treatment is carried out in order to achieve the formation of one or more alloys. Relatively strict temperature control is necessary in order to restrict alloy formation to the upper regions of the metal foam and leave unalloyed regions in the interior of the metal foam.

In step (c) of the process of the invention, metal body AX is treated thermally to achieve alloy formation between the metallic fractions of metal body A and the metal-containing powder MP so as to obtain metal body B, the maximum temperature in the thermal treatment of metal body AX being within a range from 680 to 715° C. and the total duration of thermal treatment in a temperature range from 680 to 715° C. being between 5 and 240 seconds.

The thermal treatment comprises the typically gradual heating of metal body AX and subsequent cooling to room temperature. The thermal treatment takes place under inert gas or under reducing conditions. Reducing conditions are understood to mean the presence of a gas mixture comprising hydrogen and at least one gas that is inert under the reaction conditions, a suitable example being a gas mixture containing 50% by volume of N₂ and 50% by volume of Hz. The inert gas used is preferably nitrogen. The heating can be accomplished for example in a belt furnace. Suitable heating rates are within a range from 10 to 200 K/min, preferably 20 to 180 K/min. During the thermal treatment, the temperature is typically first increased from room temperature to about 300 to 400° C. and moisture and organic constituents are removed from the coating at this temperature for a period of about 2 to 30 minutes, after which the temperature is increased until within a range from 680 to 715° C., and alloy formation takes place between metallic fractions of metal body AX and the composition of metal-containing powder MP, after which the metal body is quenched by contact with the gas environment at a temperature of approx. 200° C.

In order, for the metals involved in accordance with the invention, to restrict alloy formation to the upper regions of the metal body and to leave unalloyed regions in the interior, it is necessary that the maximum temperature in the thermal treatment of metal body AX in step (c) is within a range from 680 to 715° C., and also that the total duration of thermal treatment in a temperature range from 680 to 715° C. is between 5 and 240 seconds. The duration of thermal treatment can to a certain degree compensate for the level of the maximum treatment temperature and vice versa, but it is found that the frequency of experiments achieving alloy formation in the upper region of the metal body while at the same time leaving unalloyed regions in the interior of the metal foam decreases sharply when the maximum temperature in the thermal treatment is outside the 680 to 715° C. temperature range and/or the duration of thermal treatment in a temperature range between 680 and 715° C. is outside the range of 5 to 240 seconds. If the maximum temperature is too high and/or the metal body remains in the region of the maximum temperature for too long, this can cause alloy formation to advance into the lowest depths of the metal body so that no unalloyed regions remain. If the maximum temperature is too low and/or the metal body does not remain in the region of the maximum temperature for long enough, alloy formation does not commence at all. If materials other than the metals involved according to the invention are selected for metal body A and metal-containing powder MP, this can likewise result, despite thermal treatment in the temperature range between 680 and 715° C. for a period of 5 to 240 seconds, either in no alloy formation being obtained or no unalloyed regions remaining in the interior of the foam.

In a preferred embodiment, the ratio V of the masses of metal foam body B to metal foam body A, V=m(metal foam body B)/m(metal foam body A), is within a range from 1.1:1 to 1.5:1. In a further preferred embodiment, the ratio V of the masses of metal foam body B to metal foam body A, V=m(metal foam body B)/m(metal foam body A), is within a range from 1.2:1 to 1.4:1.

In a preferred embodiment, the metal body used in step (a) is a metal foam body in which the thickness of the metal layers that form the walls of the foam is in the range between 10 and 100 μm. In this embodiment, in addition, the thickness of the alloy layer obtained after the thermal treatment in step (c) is within the range from 3 to 30 μm. The thickness of the metal layers that form the walls of the foam and the thickness of the alloy layers optionally present thereupon can be determined by standard microscopic investigations on cross sections of the foam.

In step (d) of the process of the invention, metal body B is split so as to obtain cut metal bodies MZ, this being done using a splitting process selected from the following group: severing, machining with geometrically defined cutting edge, waterjet cutting.

Experimental investigations carried out in connection with the present invention show that the process used for the splitting of the metal bodies has an influence on the properties of the catalysts obtainable therewith. It has been found that selecting a splitting process from the group severing, machining with geometrically defined cutting edge and waterjet cutting allows catalysts having particularly advantageous properties to be obtained.

Suitable splitting processes for the purposes of the present invention are defined in the following standards:
severing in accordance with DIN 8588-0, issued in August 2013, comprising the following processes:
   shear cutting
   knife cutting
   bite cutting
   cleaving
   tearing
   breaking
machining with geometrically defined cutting edge in accordance with DIN 8589-1 to 8589-9, issued in September 2003, comprising the following processes:
   turning (DIN 8589-1)
   drilling, countersinking/counterboring, reaming (DIN 8589-2)
   milling (DIN 8589-3)
   planing, shaping (DIN 8589-4)
   broaching (DIN 8589-5)
   sawing (DIN 8589-6)
   filing, rasping (DIN 8589-7)
   machining with brushlike tools (DIN 8589-8)
   scraping, chiselling (DIN 8589-9)
waterjet cutting in accordance with SN214001; issued in 2010.

The process for the splitting of metal body B is preferably selected from the following list:
shear cutting
knife cutting
bite cutting
cleaving
scoring and breaking
sawing
waterjet cutting.

Particularly preferably, metal body B is split by knife cutting.

Experimental results obtained in connection with the present invention additionally show that the choice of a splitting process in accordance with the invention has a particularly advantageous influence on the properties of the catalysts obtainable therewith when the cut metal bodies MZ have a ratio R=CA/V of cut surface area (CA) to volume (V) of R>0.5.

The cut surface area (CA) here refers to the part of the surface of the cut metal bodies that is created by the splitting in step (d) of the process of the invention. It is assumed here that the interstices in the cut metal bodies that were not filled with metal are completely filled with metal, that is to say e.g. that the pores in the foam are completely filled and that the surfaces of the cut metal bodies created by the splitting in step (d) of the process of the invention are smooth in the respective cut plane.

V refers to the volume of the cut metal bodies, it being assumed here too that the interstices in the cut metal bodies that were not filled with metal are completely filled with metal, that is to say e.g. that the pores in the foam have been completely filled.

The ratio R=CA/V of cut surface area (CA) to volume (V) has the dimensions 1/length, but is for simplicity here expressed as a dimensionless number.

In a preferred embodiment of the present invention, at least half of the cut metal bodies MZ obtained in splitting step (d) have a ratio R=CA/V of cut surface area (CA) to volume (V) of R>0.5. In a particularly preferred embodiment of the present invention, more than 90% of the cut metal bodies MZ obtained in splitting step (d) have a ratio R=CA/V of cut surface area (CA) to volume (V) of R>0.5.

In a further aspect, the present invention further comprises processes having the following step (e): treating the cut metal bodies MZ with a leaching agent so as to obtain catalytically active metal bodies K. The treatment of cut metal bodies MZ with leaching agent serves to at least partly dissolve metal components of the applied composition of metal-containing powder MP as well as alloys between metallic fractions of metal foam bodies and the composition of metal-containing powder MP, thereby removing them from the metal body. Typically, the treatment with leaching agent removes from the metal bodies 30% to 70% by weight of the total mass of the metal components of the applied composition of metal-containing powder MP and of the alloys between metallic fractions of metal bodies and the composition of metal-containing powder MP. After the treatment of the cut metal bodies MZ with leaching agent in step (e) of the process of the invention, the proportion of the metal components of the applied composition of the metal-containing powder MP is between 3% and 30% by weight of the total mass of the catalytically active metal bodies K. Leaching agents used are typically aqueous basic solutions of NaOH, KOH, LiOH or mixtures thereof, but other leaching agents for Raney®-type catalysts known from the prior art may also be used. The temperature in the treatment with leaching agent is typically kept within a range from 20 to 120° C. The duration of the treatment with leaching agent is typically within a range from 5 minutes to 8 hours. A suitable choice of metallic components allows the metal bodies obtained as a result of the treatment with leaching agent to be used as catalysts, as disclosed for example in WO2019057533A1.

In a preferred embodiment, the treatment of cut metal bodies MZ with leaching agent is performed for a period within a range from 5 minutes to 8 hours, at a temperature within a range from 20 to 120° C., the leaching agent being an aqueous NaOH solution having an NaOH concentration of between 1% and 30% by weight.

The catalytically active metal bodies K may in some embodiments be modified in a further step (f) by postdoping with further metals; these doping elements, also referred to as promoter elements, are preferably selected from the transition metals. For postdoping, the metal bodies are treated with a preferably aqueous solution of the doping element(s) to be applied. In order not to damage the metal bodies, the doping solution typically has a pH of ≥4. To the solution of the doping element(s) to be applied may be added a chemically reducing component to bring about reductive deposition of the dissolved doping element(s) on the metal body. Preferred doping elements for the modification are selected from the group consisting of Mo, Pt, Pd, Rh, Ru, Cu or mixtures thereof. Suitable doping methods are described for example in WO 2019/057533, on pages 20 to 25.

The metal bodies activated in step (e) and optionally postdoped in step (f) may be either used immediately as catalysts or stored. To prevent surface oxidation processes and an associated reduction in catalytic activity, the metal bodies are after activation preferably stored under water.

In a further aspect, the present invention further encompasses metal bodies obtainable by one of the processes of the invention.

Activated and optionally doped metal bodies obtainable by one of the processes of the invention can be used as catalysts for numerous catalysed chemical reactions of organic compounds in particular, for example hydrogenation, isomerization, hydration, hydrogenolysis, reductive amination, reductive alkylation, dehydrogenation, oxidation, dehydration and rearrangement, and for hydrogenation reactions in particular. The catalysts of the invention are in principle highly suitable for all hydrogenation reactions catalysed by Raney®-type metal catalysts. Preferred uses of the catalysts of the invention are selective methods of hydrogenation of carbonyl compounds, olefins, aromatic rings, nitriles and nitro compounds. Specific examples are the hydrogenation of carbonyl groups, hydrogenation of nitro groups to amines, hydrogenation of polyols, hydrogenation of nitriles to amines, for example the hydrogenation of fatty nitriles to fatty amines, dehydration of alcohols, reductive alkylation, hydrogenation of olefins to alkanes and the hydrogenation of azides to amines. Particular preference is given to use in the hydrogenation of carbonyl compounds.

In a further aspect, the present invention therefore encompasses the use of activated and optionally doped metal bodies obtainable by one of the processes of the invention as catalysts for chemical transformations, preferably for chemical transformations selected from hydrogenation, isomerization, hydration, hydrogenolysis, reductive amination, reductive alkylation, dehydrogenation, oxidation, dehydration and rearrangement.

### EXAMPLES

1. Application of Metal Powder Compositions to Metal Bodies

40 g of binder solution (2.5% by weight of polyethyleneimine in aqueous solution) was first sprayed onto each of two flat-form metal foam bodies made of nickel and having a weight per unit area of 1000 g/m² and an average pore size of 580 μm (manufacturer: AATM, 1.9 mm*300 mm*860 mm). This was immediately followed by the application (approx. 400 g/m²) to the metal bodies of dry pulverulent aluminium (particle size d99=90 μm) in a mixture with 3% by weight of pulverulent Ceretan®-7080 wax (melting point within a range from 140 to 160° C.).

2. Melting and Resolidification of Wax Components

Both metal foam bodies were then heated to 160° C. in a laboratory oven and then cooled back down to room temperature.

3. Thermal Treatment for Alloy Formation

Both metal foam bodies were then subjected to a thermal treatment for alloy formation under a nitrogen atmosphere in a sintering belt furnace (manufacturer: Sarnes). In this treatment, the furnace was heated from room temperature to 715° C. over the course of 15 min. The total duration of thermal treatment in a temperature range between 680° C. and 715° C. was 120 s. The metal foam was then quenched by contacting with a nitrogen atmosphere at 200° C.

4. Splitting of the Metal Bodies

The sintered metal foam bodies were afterwards split into cut metal bodies. This was done by cutting one of the metal foam bodies with a laser under inert gas (N₂). An Nd:YAG laser manufactured by Trumpf and having a maximum power of 5 kW was used for this purpose. In addition to the inert gas (N₂), a cooling gas (N₂) was employed to prevent the metal foam from calcining. The laser was used to cut 4 mm×4 mm pieces out of the metal foam body. This afforded cut metal foam bodies having the dimensions 4 mm*4 mm*1.9 mm (length, width, height).

The other metal foam bodies were cut using knives. This was done by first cutting the metal foam body in one direction with several rotating knives on one axis, creating a comb-like structure having 4 mm wide metal body strips instead of teeth. These metal body strips were then in turn cut crosswise with the rotating knives on one axis at a distance of 4 mm. This afforded cut metal foam bodies having the dimensions 4 mm*4 mm*1.9 mm (length, width, height).

5. Activation

The cut metal foam bodies were in the next step activated through treatment with a leaching agent. For this, the aluminium fractions present in the intermetallic phases were leached out of the intermetallic phases by treatment with aqueous NaOH (10% by weight), (the suspension of the cut metal foam bodies being heated in aqueous NaOH (10% by weight) from room temperature to 55° C. over a period of 30 minutes, after which the temperature was held at 55° C. for 30 minutes). The alkali was then removed and the cut metal foam bodies were washed with water for approx. one hour so as to obtain activated catalysts.

6. Measurement of Activity

These activated catalysts were then investigated in respect of their activity. For this, the catalysts obtained by laser cutting were compared with the catalysts obtained by knife cutting. The hydrogenation of 1-hexene to n-hexane in a stirred-tank reactor was tested. The course of the reaction was monitored on the basis of the H₂ consumption.

### Conditions:

63 g 1-hexene
250 g isopropanol
1.5 g catalyst
7.5 bar H₂
30° C.
1500 rpm

### Result:

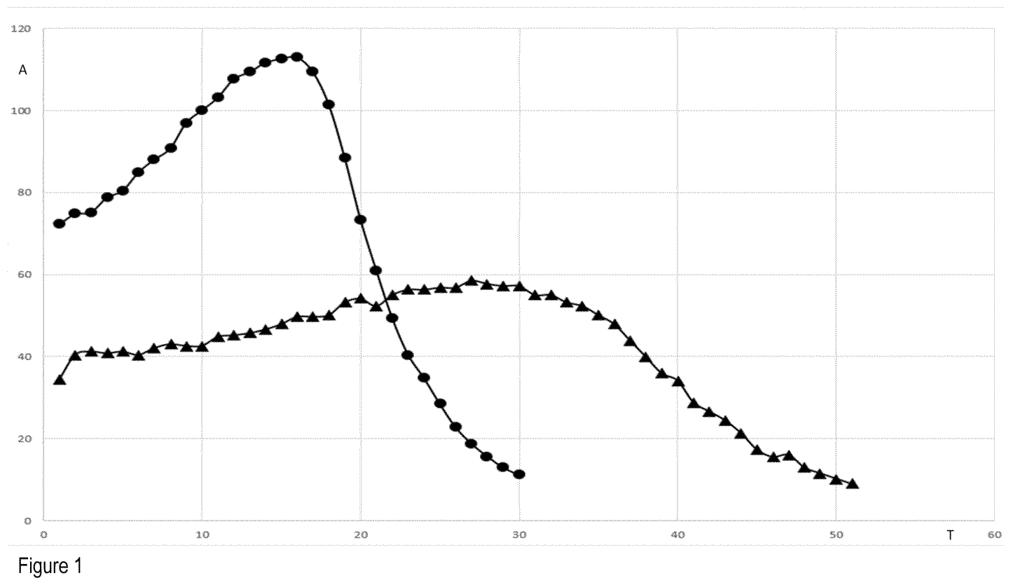

The hydrogenation proceeded significantly more quickly with the catalysts obtained by knife cutting than with the catalysts obtained by laser cutting. The results are shown in FIG. 1: knife-cut catalyst (circles), laser-cut catalyst (triangles).
Ordinate: Activity in [ml_{H2}/(min*g_{cat})
Abscissa: Time (one time unit corresponds to 5 min)

7. Other Results:

Experiments with metal foam bodies made of cobalt that otherwise corresponded to the experiments shown above with metal foam bodies made of nickel yielded a qualitatively identical result: The hydrogenation proceeded significantly more quickly with the catalysts obtained by knife cutting than with the catalysts obtained by laser cutting.

1-15. (canceled)

16. A process comprising the following steps:
(a) providing a metal body A, wherein the metal body is a metal foam body, a metal net, a metal nonwoven, a metal knit, or a metal mesh; and wherein the metal body is made of nickel, cobalt, a cobalt-nickel alloy, a nickel-iron alloy, a nickel-chromium alloy, or copper;
(b) applying a metal-containing powder MP to metal body A so as to obtain metal body AX, wherein MP comprises pulverulent aluminium, pulverulent chromium, a pulverulent alloy of aluminium and chromium, or combinations thereof;
(c) treating metal body AX thermally to achieve alloy formation between the metallic fractions of metal body A and the metal-containing powder MP so as to obtain metal body B, wherein the maximum temperature in the thermal treatment of metal body AX is within a range from 680 to 715° C. and the total duration of thermal treatment is between 5 and 240 seconds;
(d) splitting of the metal bodies B so as to obtain cut metal bodies MZ, wherein the splitting of the metal bodies employs a splitting process selected from the group consisting of: severing; machining with a geometrically defined cutting edge; and waterjet cutting.

17. The process of claim 16, wherein metal body A consists of nickel or cobalt.

18. The process of claim 16, wherein the metal-containing powder MP is pulverulent aluminium.

19. The process of claim 16, wherein the process for the splitting of metal body B is selected from the group consisting of: shear cutting; knife cutting; bite cutting; cleaving; scoring; and breaking, sawing; and waterjet cutting.

20. The process of claim 16, wherein the metal body used in step (a) is a metal foam body.

21. The process of claim 20, wherein the metal foam body used in step (a) has a specific BET surface area of 100 to 20 000 m²/m³.

22. The process of claim 20, wherein the metal foam body used in step (a) has a specific BET surface area of 1000 to 6000 m²/m³.

23. The process of claim 21, wherein the metal foam body used in step (a) has a porosity of 0.50 to 0.95.

24. The process of claim 16, wherein at least half of the cut metal bodies MZ obtained have a ratio R=CA/V of cut surface area (CA) to volume (V) of R>0.5.

25. The process of claim 16, further comprising the following step:
(e) treating cut metal bodies MZ with a leaching agent so as to obtain catalytically active metal bodies K.

26. The process of claim 25, wherein the treatment of cut metal bodies MZ with leaching agent is performed for a period within a range of from 5 minutes to 8 hours, at a temperature in a range of from 20 to 120° C., and wherein the leaching agent is an aqueous NaOH solution having an NaOH concentration of between 1% and 30% by weight.

27. The process of claim 25, further comprising the following step:
(f) postdoping the catalytically active metal bodies K with a promoter element selected from Mo, Pt, Pd, Rh, Ru, Cu or mixtures thereof.

28. The process of claim 17, wherein the metal-containing powder MP is pulverulent aluminium.

29. The process of claim 17, wherein the process for the splitting of metal body B is selected from the group consisting of: shear cutting; knife cutting; bite cutting; cleaving; scoring; and breaking, sawing; and waterjet cutting.

30. The process of claim 29, wherein the metal body used in step (a) is a metal foam body.

31. The process of claim 30, wherein the metal foam body used in step (a) has a specific BET surface area of 1000 to 6000 m²/m³.

32. The process of claim 31, further comprising the following step:
(e) treating cut metal bodies MZ with a leaching agent so as to obtain catalytically active metal bodies K.

33. The process of claim 32, further comprising the following step:
(f) postdoping the catalytically active metal bodies K with a promoter element selected from Mo, Pt, Pd, Rh, Ru, Cu or mixtures thereof.

34. A cut metal body MZ obtainable by the process of claim 16.

35. A catalytically active metal body K obtainable by the process of claim 32.
